(19) United States
(12) Patent Application Publication
(10) Pub. No.: US 2026/0126150 A1
(43) Pub. Date: May 7, 2026

(54) Accessory Mounting Device

(71) Applicant: David Behning, Lester Prairie, MN (US)

(72) Inventor: David Behning, Lester Prairie, MN (US)

(21) Appl. No.: 19/041,785

(22) Filed: Jan. 30, 2025

Related U.S. Application Data
(63) Continuation-in-part of application No. 18/940,547, filed on Nov. 7, 2024.

(51) Int. Cl. F16M 13/02; F16B 2/22; F21V 21/088

(52) U.S. Cl. CPC F16M 13/022; F16B 2/22; F21V 21/088

(57) ABSTRACT

An accessory mounting device includes a rail and a string decoration. A plurality of clips are couplable to the string decoration to releasably secure the string decoration along the rail. Each clip includes a rib having an upper surface, a lower surface, and a pair of opposing ends. The rib has a length that is measured between the pair of opposing ends. The length of the rib is complementary to a width of the rail. The lower surface is concavely arcuate between the pair of opposing ends wherein the lower surface arches above the rail to define a void between the rail and the lower surface of the rib. A pair of legs are coupled to the rib. Each leg has a length that is complementary to a height of the rail wherein the pair of legs extend between the rib and a bottom wall of the rail.

### (b) CROSS-REFERENCE TO RELATED APPLICATIONS

This application is a continuation in part of U.S. application Ser. No. 18/940,547, filed on Nov. 7, 2024.

### (C) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to mounting systems and more particularly pertains to a new mounting system for mounting accessories to deck railings.

### (2) Description of Related Art Including Information Disclosed Under 37 CFR 1.97 and 1.98

The prior art relates to mounting systems. More particularly, the prior art relates to systems and devices for mounting accessories to decks. Decks are a very popular part of homes, for entertaining guests and simply relaxing outdoors. The prior art discloses systems and devices for mounting accessories, such as lights, to the post caps of such railings. However, such systems and devices restrict the user to placing the accessories on the post caps. Thus, there is a need in the art for a mounting device that can be used to mount accessories along the top rail of a railing, providing the user with increased flexibility and design options. Ideally, such a mounting device could be repeatedly coupled to and decoupled from the top rail of the railing, without damaging the top rail of the railing.

### (h) BRIEF SUMMARY OF THE INVENTION

An embodiment of the disclosure meets the needs presented above by generally comprising a rail. A string decoration is removably positionable along the rail. A plurality of clips are removably couplable to the rail. The plurality of clips are couplable to the string decoration wherein the plurality of clips releasably secure a position of the string decoration along the rail. Each clip of the plurality of clips includes a rib having an upper surface, a lower surface, and a pair of opposing ends. The rib has a length that is measured between the pair of opposing ends. The length of the rib is complementary to a width of the rail. The lower surface is concavely arcuate between the pair of opposing ends wherein the lower surface arches above the rail to define a void that positioned between the rail and the lower surface of the rib. A pair of legs are coupled to the rib. Each leg of the pair of legs has a length that is complementary to a height of the rail wherein the pair of legs are positioned to extend between the rib and a bottom wall of the rail.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of an accessory mounting device according to an embodiment of the disclosure.

FIG. 2 is a front view of an embodiment of the disclosure.

FIG. 3 is a side view of an embodiment of the disclosure.

FIG. 4 is an in-use view of an embodiment of the disclosure.

FIG. 5 is an in-use view of an embodiment of the disclosure.

FIG. 6 is an in-use view of an embodiment of the disclosure.

FIG. 7 is an isometric view of an embodiment of the disclosure.

FIG. 8 is an isometric view of an embodiment of the disclosure.

FIG. 9 is a front view of an embodiment of the disclosure.

FIG. 10 is an isometric view of an embodiment of the disclosure.

FIG. 11 is an isometric view of an embodiment of the disclosure.

FIG. 12 is an isometric view of an embodiment of the disclosure.

FIG. 13 is a front view of an embodiment of the disclosure.

FIG. 14 is a front view of an embodiment of the disclosure.

FIG. 15 is an isometric view of an embodiment of the disclosure.

FIG. 16 is an isometric view of an embodiment of the disclosure.

FIG. 17 is a front view of an embodiment of the disclosure.

FIG. 18 is a front view of an embodiment of the disclosure.

FIG. 19 is an isometric view of an embodiment of the disclosure.

FIG. 20 is a front view of an embodiment of the disclosure.

### (J) DETAILED DESCRIPTION OF THE INVENTION

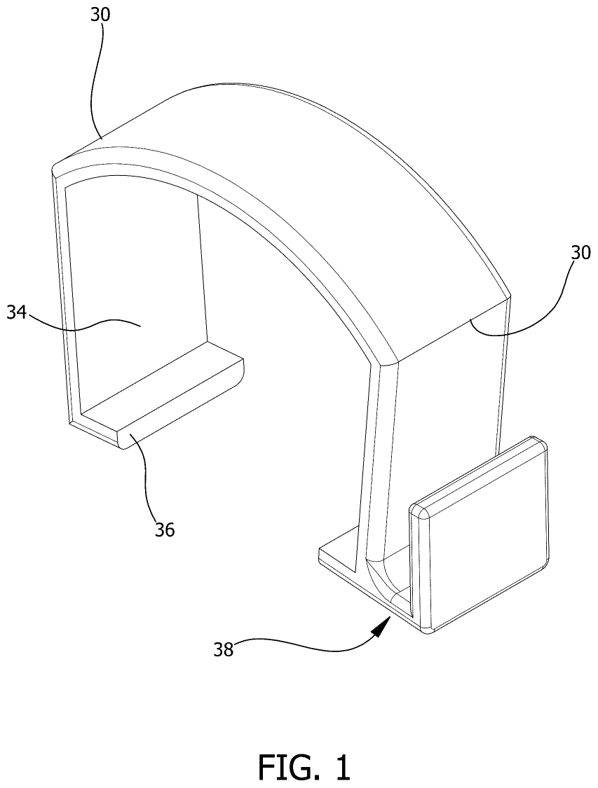

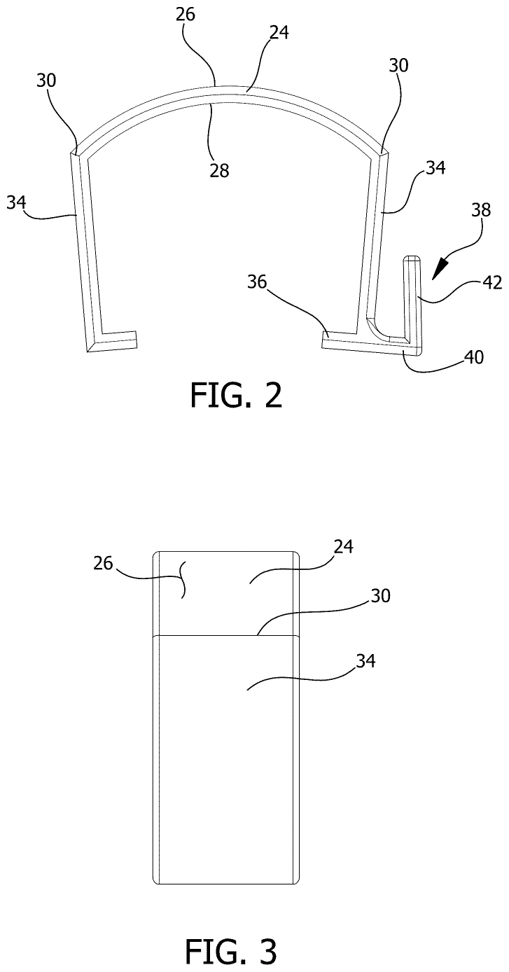

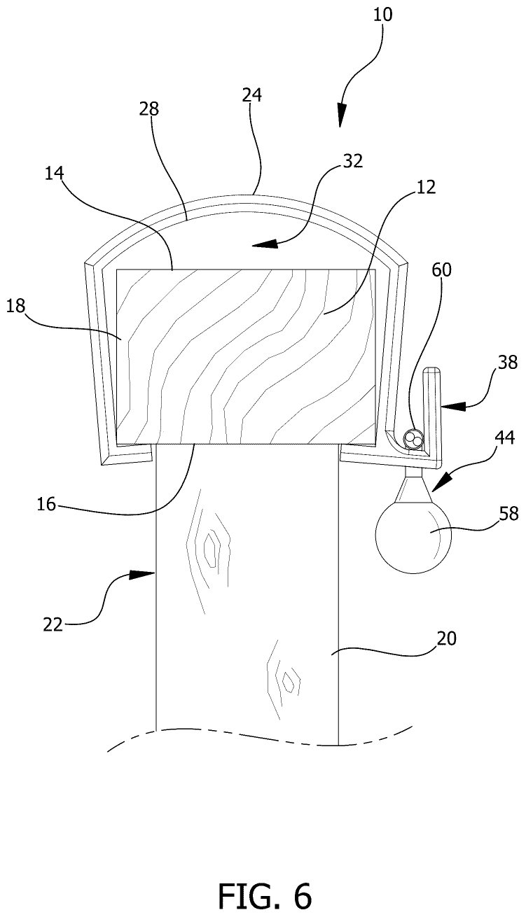

With reference now to the drawings, and in particular to FIGS. 1 through 20 thereof, a new mounting system embodying the principles and concepts of an embodiment of the disclosure and generally designated by the reference numeral 10 will be described.

As best illustrated in FIGS. 1 through 20, the accessory mounting device 10 generally comprises a rail 12 having a top wall 14, a bottom wall 16, and a pair of opposing lateral walls 18 that extend between the top wall 14 and the bottom wall 16. The pair of opposing lateral walls 18 may be parallel to each other. The rail 12 generally has a width that is measured between the pair of opposing lateral walls 18 and a height that is measured between the top wall 14 and the bottom wall 16. The rail 12 may be configured to extend between a plurality of balusters 20 to define a railing 22.

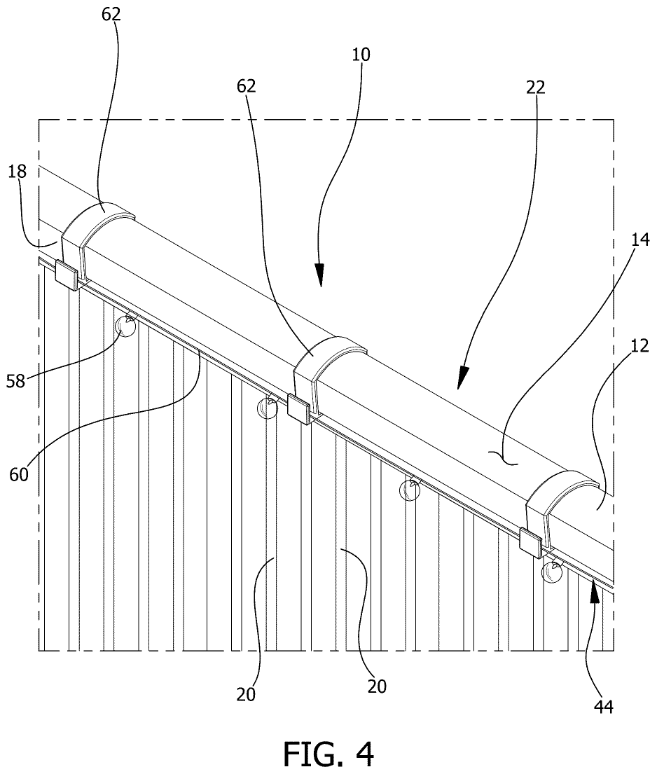

A string decoration 44 is removably positionable along the rail 12. Examples of the string decoration 44 include a string of lights, as shown in FIG. 4-6, or a garland. However, other embodiments of the string decoration 44 are also contemplated. Generally speaking, the string decoration 44 includes a plurality of ornaments 58 and a wire 60 that is coupled to and extends between the plurality of ornaments 58.

A plurality of clips 62 are removably couplable to the rail 12. The plurality of clips 62 are couplable to the string decoration 44 wherein the plurality of clips 62 secure a position of the string decoration 44 along the rail. The plurality of clips 62 are generally spaced from each other along a length of the rail 12, as shown in FIG. 4.

Each clip of the plurality of clips 62 generally includes a rib 24. The rib 24 has an upper surface 26, a lower surface 28, and a pair of opposing ends 30. The rib 24 may have a length that is measured between the pair of opposing ends 30. While the rib 24 is fully coupled to the rail 12, the length of the rib 24 is generally complementary to the width of the rail 12.

The lower surface 28 may be concavely arcuate between the pair of opposing ends 30. In such embodiments, while the rib 24 is fully coupled to the rail 12, the lower surface 28 generally arches above the top wall 14 of the rail 12 to define a void 32 that is positioned between the top wall 14 of the rail 12 and the lower surface 28 of the rib 24. The upper surface 26 may be convexly arcuate between the pair of opposing ends 30.

A pair of legs 34 are coupled to the rib 24. Each leg of the pair of legs 34 has a length that is complementary to the height of the rail 12. In other words, the pair of legs 34 are positionable to extend between the rib 24 and the bottom wall 16 of the rail 12 while the rib 24 is positioned on the top wall 14 of the rail 12. Each leg of the pair of legs 34 generally extends from a respective opposing end of the pair of opposing ends 30 of the rib 24. The pair of legs 34 may be angled to extend downwardly from the rib 24 and inwardly toward each other, particularly when the rib 24 is decoupled from the rail 12.

A pair of projections 36 may be coupled to the pair of legs 34 wherein each projection of the pair of projections 36 is positioned on a respective leg of the pair of legs 34. Each projection of the pair of projections 36 extends inwardly from the respective leg of the pair of legs 34 wherein the pair of projections 36 extend toward each other beneath the rib 24. More specifically, each projection of the pair of projections 36 may be positioned distally on the respective leg of the pair of legs 34 relative to the rib 24. The pair of projections 36 may be positionable against the bottom wall 16 of the rail 12 to removably couple the rib 24 to the rail 12. The pair of projections 36 may be coplanar with each other.

The pair of legs 34 may be pivotable relative to the rib 24. For example, the pair of legs 34 may be made of a resiliently deformable material, such as a semi-flexible plastic, wherein the pair of legs 34 are configured to pivot outwardly relative to each other while the rib 24 is being coupled to the rail 12. By pivoting outwardly relative to each other, the pair of legs 34 facilitate the pair of projections 36 in sliding downwardly across the pair of opposing lateral walls 18 of the rail 12.

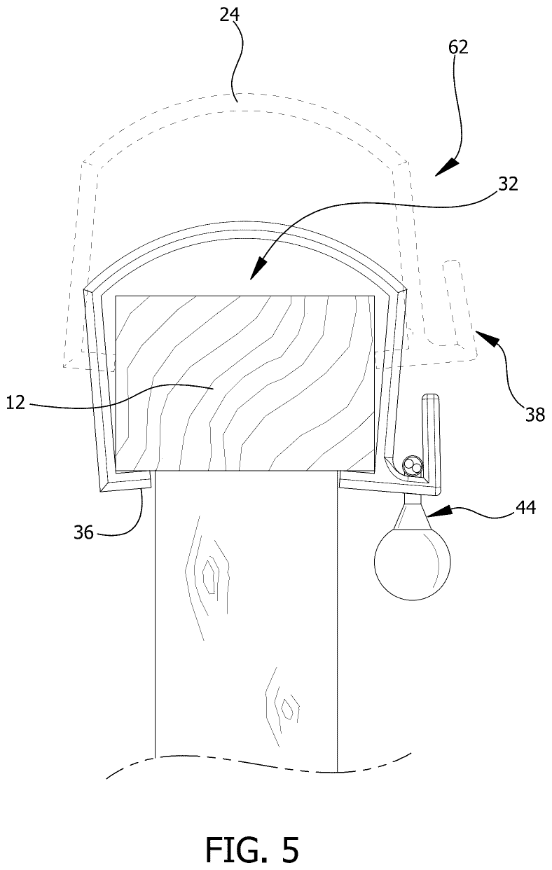

When the pair of legs 34 are pivoted outwardly relative to each other, as shown in FIG. 5, the length of the rib 24 may exceed the width of the rail 12 because movement of the pair of legs 34 outwardly relative to each other may urge the pair of opposing ends of the rib 24 away from each other. In other words, when the pair of projections 36 are positioned against the pair of opposing lateral walls 18 of the rail 12, the rib 24 may straighten out, reducing the curvature of the upper surface 26 and the lower surface 28 of the rib 24.

Once the pair of projections 36 are beneath the bottom wall 16 of the rail 12, the pair of legs 34 may pivot back inwardly toward each other such that the pair of legs 34 exert inward pressure on the pair of opposing lateral walls 18 of the rail 12. The inward pressure from the pair of legs 34 and the placement of the pair of projections 36 against the bottom wall 16 of the rail 12 secures each clip of the plurality of clips 62 over the top wall 14 of the rail 12. In some embodiments, the pair of legs 34 may be parallel to each other while the rib 24 is positioned over the rail 12. Additionally, once the pair of projections 36 are beneath the bottom wall 16 of the rail 12, the length of the rib 24 is generally complementary to the width of the rail 12 as described above.

A claw 38 may be coupled to an associated leg of the pair of legs 34 of each clip of the plurality of clips 62. The claw 38 generally includes a ledge 40 that extends outwardly from the associated leg of the pair of legs 34. Accordingly, the ledge 40 extends outwardly relative to a respective opposing lateral wall of the pair of opposing lateral walls 18 of the rail 12.

A shoulder 42 is coupled to the ledge 40. The shoulder 42 is generally angled to extend upwardly from the ledge 40 and inwardly toward the associated leg of the pair of legs 34. More generally, the shoulder 42 releasably secures the string decoration 44 proximate to the respective opposing lateral wall of the pair of opposing lateral walls 18 of the rail 12 when each clip of the plurality of clips 62 is coupled to the rail 12. In other words, a distance between the shoulder 42 and the associated leg of the pair of legs 34 may decrease moving upwardly away from the ledge 40. The distance is generally measured parallel to the ledge 40. The distance between the shoulder 42 and the associated leg of the pair of legs 34 adjacent to the ledge 40 may be configured to complement a diameter of the string decoration 44 to secure a position of the string decoration 44 within the claw 38.

The shoulder 42 and the ledge 40 of the claw 48 may secure the wire 60 of the string decoration 44 proximate to the respective opposing lateral wall of the pair of opposing lateral walls 18 of the rail 12, as shown in FIG. 4-6. Embodiments according to FIG. 1-6, 8, 10, 11-15, and 17 may be preferred for securing the wire 60 of the string decoration 44 proximate to the respective opposing lateral wall of the pair of opposing lateral walls 18 of the rail 12. The plurality of ornaments 58 may be positionable between adjacent clips of the plurality of clips 62.

In embodiments according to FIG. 1-3, 8, 10, 15, and 17, the ledge 40 may be horizontally coplanar with a respective projection of the pair of projections 36. The respective projection of the pair of projections 36 is coupled to the associated leg of the pair of legs 34.

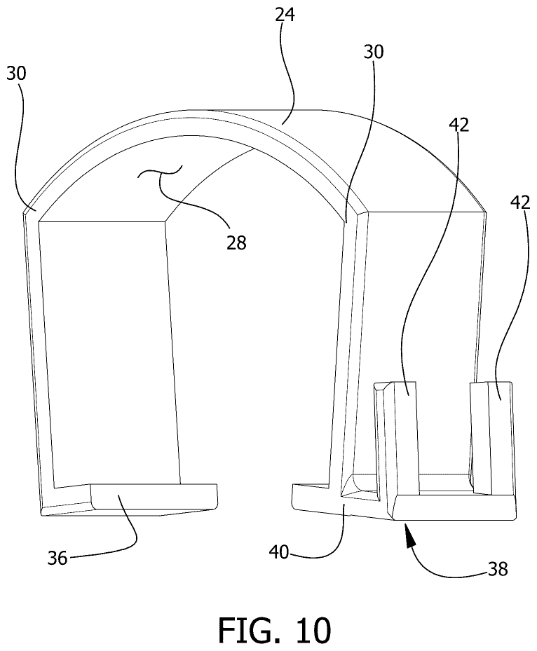

Additionally, as shown in FIG. 1-3, 15, and 17, the shoulder 42 may have a width that is equal to a width of the ledge 40. Alternatively, as shown in FIGS. 8 and 10, the shoulder 42 may be one of a pair of shoulders that are spaced from each other across the ledge 40. For example, the pair of shoulders may be positioned on opposing ends of the ledge 40.

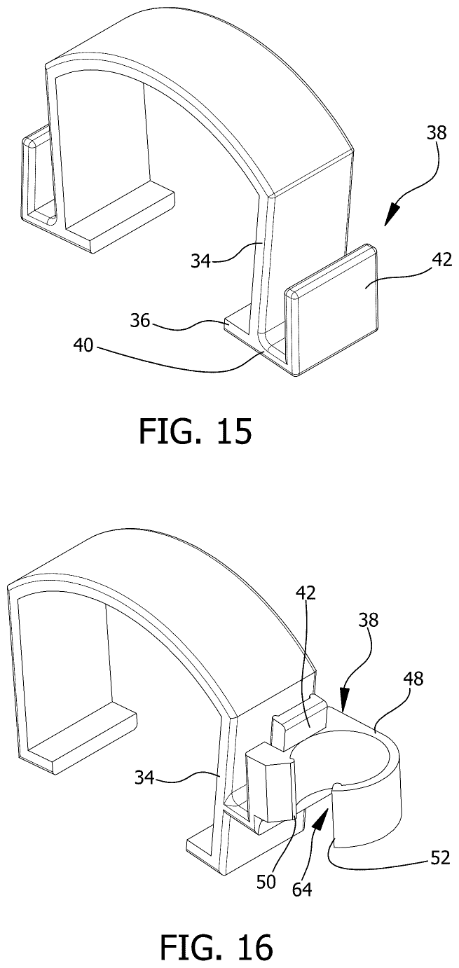

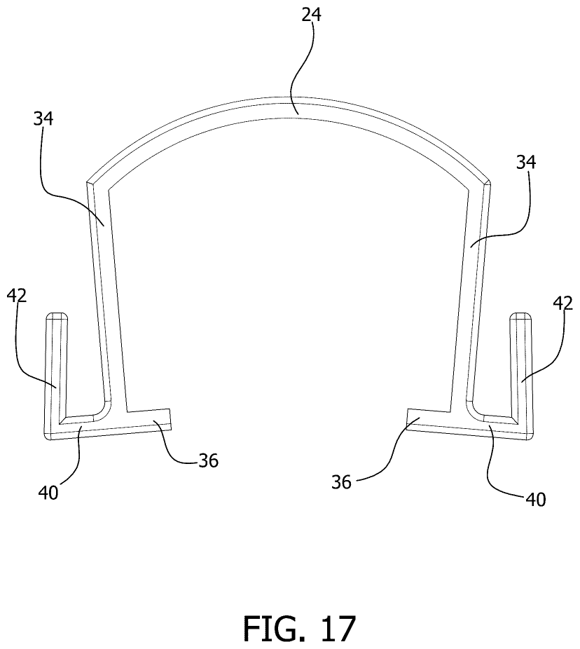

FIGS. 15 and 17 provide an example embodiment where the claw 38 is one of a pair of claws. Each claw 38 of the pair of claws is coupled to an associated leg of the pair of legs 34. Accordingly, each claw 38 of the pair of claws can releasably secure an associated string decoration 44 of a pair of string decorations to the rail 12.

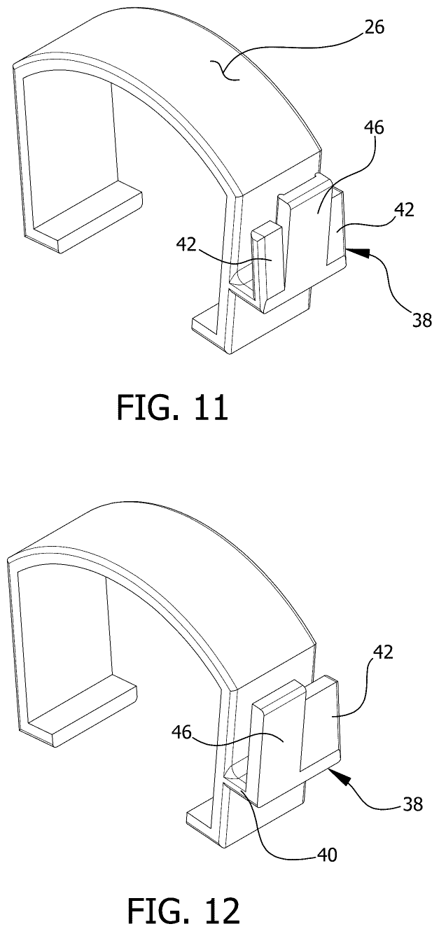

Embodiments according to FIG. 11-14, 16, and 18-20 show that the ledge 40 may be horizontally offset from the respective projection of the pair of projections 36. In other words, the ledge 40 may be positioned to extend from the associated leg of the pair of legs 34 between the rib 24 and the respective projection of the pair of projections 36.

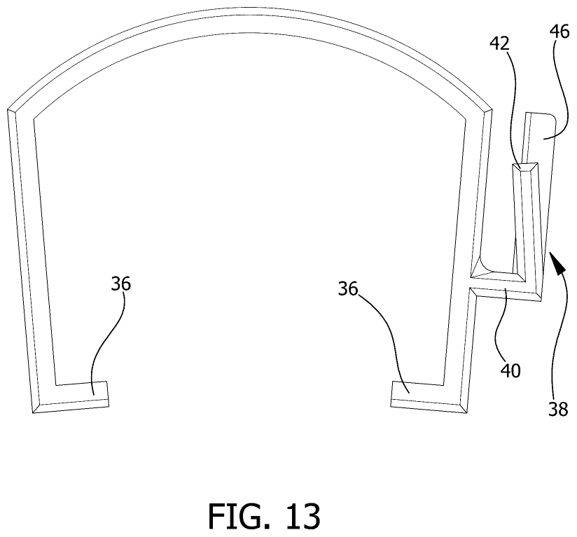

FIGS. 11 and 13 show that the shoulder 42 may be one of a pair of shoulders that are spaced from each other across the ledge 40. For example, the pair of shoulders may be positioned on opposing ends of the ledge 40. The claw 38 may further comprise a panel 46 that is coupled to and extends upwardly from the ledge 40. In these embodiments, the panel 46 is generally positioned between the pair of shoulders. The panel 46 may have a width that exceeds a width of each shoulder 42 of the pair of shoulders. The panel 46 may extend a full distance between the pair of shoulders. The panel 46 may be perpendicular to the ledge 40.

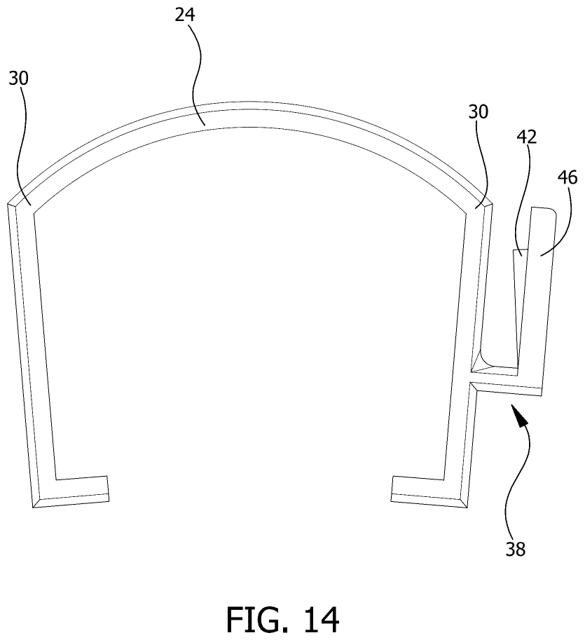

Alternatively, as shown in FIGS. 12 and 14, the shoulder 42 may have a width that is less than a width of the ledge 40. In such embodiments, the panel 46 may still be coupled to and extend upwardly from the ledge 40. However, in these embodiments, the panel 46 may be positioned adjacent to the shoulder 42, rather than between the pair of shoulders. The ledge 40 may have a length that is equal to a combined length of the shoulder 42 and the panel 46. The panel 46 may be perpendicular to the ledge 40.

In other alternative embodiments, which are generally represented by FIGS. 16 and 18-20, the shoulder 42 has a width that is less than a width of the ledge 40. The shoulder 42 is generally centered on the ledge 40 in these embodiments. The claw 38 may further include a fin 48 that is coupled to the shoulder 42. The fin 48 extends outwardly from the shoulder 42 and away from the associated leg of the pair of legs 34.

The fin 48 generally includes a primary end 50 and a secondary end 52 that is spaced from the primary end 50 to define a channel 64 extending through the fin 48 between the primary end 50 and the secondary end 52. For example, an inner surface 54 of the fin 48 is generally concavely arcuate between the primary end 50 and the secondary end 52 wherein the fin 48 defines a C-shape. The channel 64 is generally configured to receive the string decoration 44. For example, an ornament of the plurality of ornaments 58 may be positionable within the channel 64.

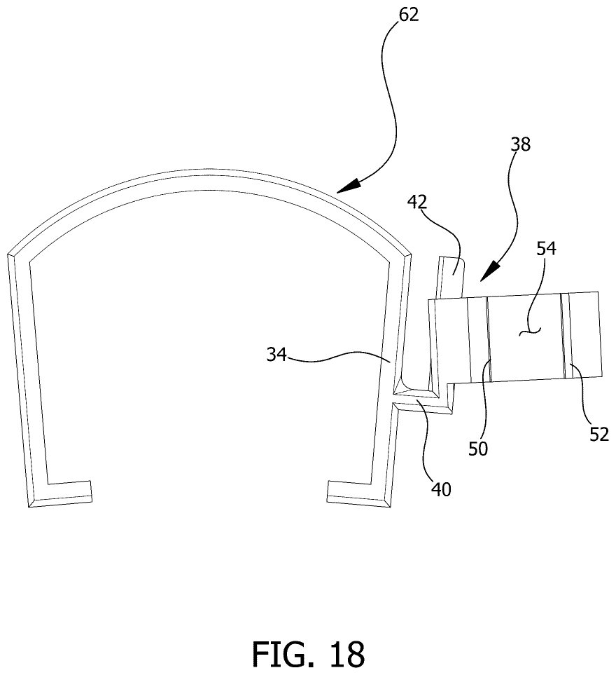

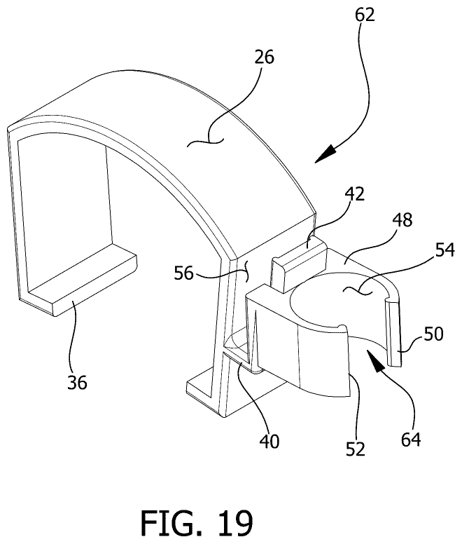

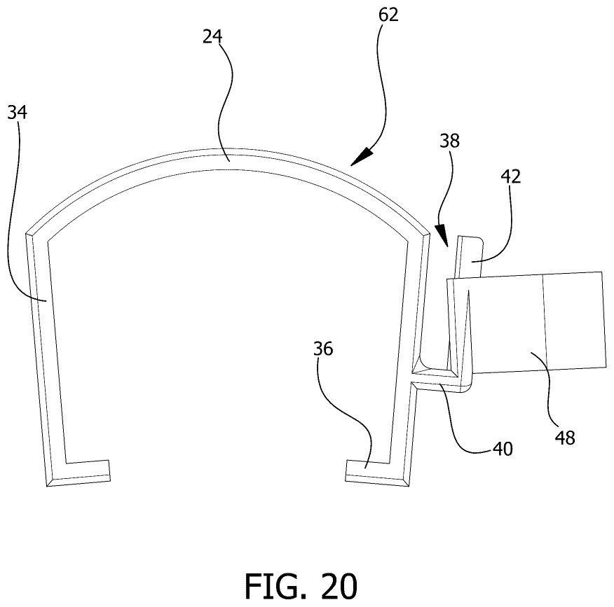

As shown in FIGS. 16 and 18, the primary end 50 of the fin 48 may be positioned proximate to the associated leg of the pair of legs 34. In such embodiments, the channel 64 may be perpendicular to an exterior surface 56 of the associated leg of the pair of legs 34. Alternatively, as shown in FIGS. 19 and 20, each of the primary end 50 and the secondary end 52 of the fin 48 may be spaced from the associated leg of the pair of legs 34. The primary end 50 and the secondary end 52 may be aligned with each other wherein the channel 64 extends toward the exterior surface 56 of the associated leg of the pair of legs 34.

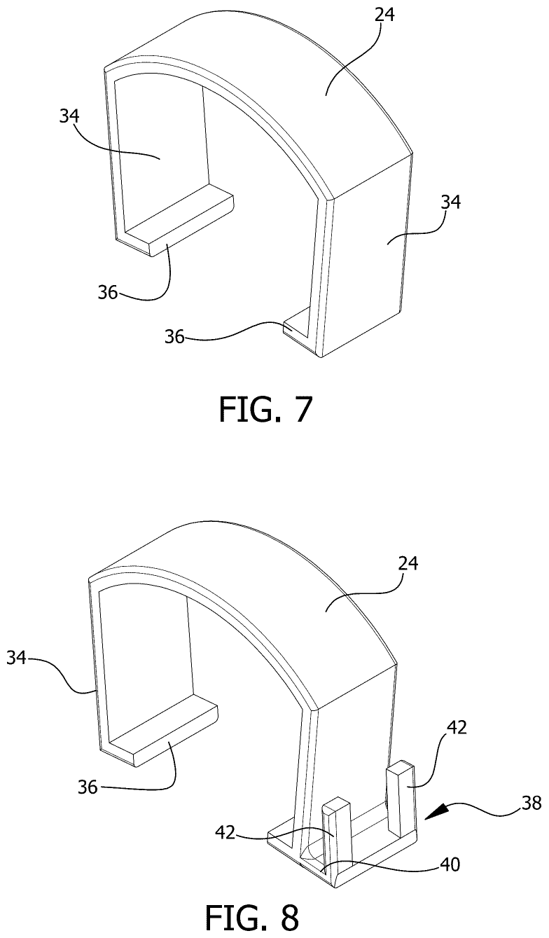

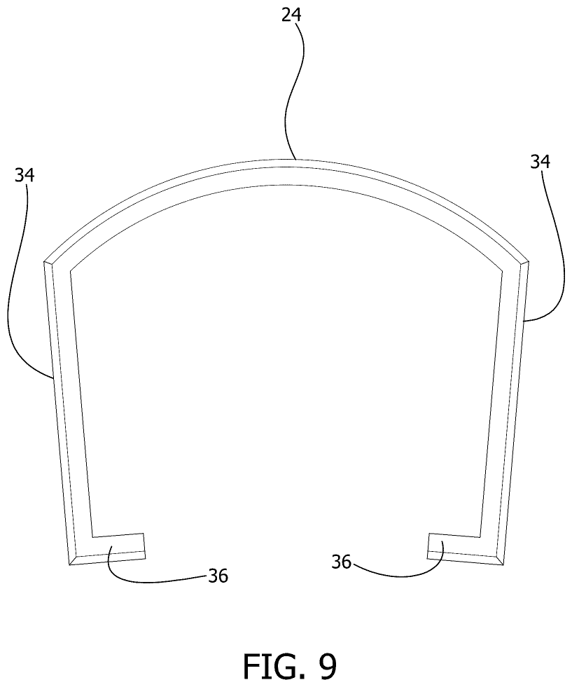

Embodiments according to FIGS. 7 and 9 generally do not include the claw 38. In such embodiments, the wire 60 of the string decoration 44 may be positionable within the void 32 defined by the distance between the top wall 14 of the rail 12 and the lower surface 28 of the rib 24. Accordingly, the rib 24 may secure the string decoration 44 proximate to the top wall 14 of the rail 12.

In use, a method of hanging a string decoration 44 along the rail 12 of the railing 22 may include placing the plurality of clips 62 along the length of the rail 12. More specifically, the rib 24 may be positioned over the top wall 14 of the rail 12 with the pair of legs 34 extending downwardly along the pair of opposing lateral walls 18 of the rail 12. The pair of projections 36 can be positioned against the bottom wall 16 of the rail 12 to secure each clip of the plurality of clips 62 to the rail 12.

The string decoration 44 can be hung within the claw 38 extending outwardly from the associated leg of the pair of legs 34. In embodiments according to FIG. 7-9, the string decoration 44 can be positioned within the void 32 defined by the distance between the top wall 14 of the rail 12 and the lower surface 28 of the rib 24. In embodiments according to FIG. 1-6, 8, 10, 11-15, and 17, the wire 60 of the string decoration 44 may be secured between the shoulder 42 and the associated leg of the pair of legs 34. FIGS. 16 and 18-20 provide examples of embodiments where an ornament of the plurality of ornaments 58 of the string decoration 44 can be secured within the channel 64 64 extending into the fin 48.

As shown in FIG. 5 and described above, the pair of legs 34 may be resiliently deformable, or semi-flexible, wherein the pair of legs 34 are pivotable outwardly and away from each other as the pair of legs 34 are pushed downwardly over the rail 12. In other words, the pair of projections 36 may push the pair of legs 34 outwardly relative to the pair of opposing lateral walls 18 of the rail 12 until the pair of projections 36 are positioned beneath the bottom wall 16 of the rail 12.

The void 32 positioned between the top wall 14 of the rail 12 and the lower surface 28 of the rib 24 may facilitate movement of the rib 24 along the rail 12 and removal of each clip of the plurality of clips 62 from the rail 12. Because the rib 24 arches above the top wall 14 of the rail 12 when each clip of the plurality of clips 62 is coupled to the rail 12, the rib 24 acts as a sort of handle. The void 32 provides space between the rib 24 and the rail 12 for a user to grip the rib 24 of each clip of the plurality of clips 62. Thus, the arcuate shape of the rib 24 is configured to facilitate the user in coupling each clip of the plurality of clips 62 to the rail 12, in moving each clip of the plurality of clips 62 along the length of the rail 12, and in removing each clip of the plurality of clips 62 from the rail 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

I claim:

1. A mounting system comprising:
a rail;
a string decoration being removably positionable along the rail; and
a plurality of clips being removably couplable to the rail, the plurality of clips being couplable to the string decoration wherein the plurality of clips releasably secure a position of the string decoration along the rail, each clip of the plurality of clips including:
a rib having an upper surface, a lower surface, and a pair of opposing ends, the rib having a length being measured between the pair of opposing ends, the length of the rib being complementary to a width of the rail, the lower surface being concavely arcuate between the pair of opposing ends wherein the lower surface arches above the rail to define a void being positioned between the rail and the lower surface of the rib; and
a pair of legs being coupled to the rib, each leg of the pair of legs having a length being complementary to a height of the rail wherein the pair of legs are positioned to extend between the rib and a bottom wall of the rail.

2. The mounting system of claim 1, further comprising a pair of projections being coupled to the pair of legs wherein each projection of the pair of projections is positioned on a respective leg of the pair of legs, each projection of the pair of projections extending inwardly from the respective leg of the pair of legs wherein the pair of projections extend toward each other.

3. The mounting system of claim 1, further comprising a claw being coupled to an associated leg of the pair of legs of the clip, the claw including:
a ledge extending from the associated leg of the pair of legs; and
a shoulder being coupled to the ledge, the shoulder being angled to extend upwardly from the ledge and inwardly toward the associated leg of the pair of legs wherein the shoulder is configured to releasably secure the string decoration to each clip of the plurality of clips.

4. The mounting system of claim 4, wherein the ledge of the claw is horizontally coplanar with a respective projection of the pair of projections.

5. The mounting system of claim 4, wherein the shoulder is one of a pair of shoulders being spaced from each other across the ledge and wherein the pair of shoulders are positioned on opposing ends of the ledge.

6. The mounting system of claim 3, wherein the ledge is horizontally offset from a respective projection of the pair of projections.

7. The mounting system of claim 6, wherein the ledge is positioned between the rib and the respective projection of the pair of projections.

8. The mounting system of claim 6, wherein the shoulder is one of a pair of shoulders being spaced from each other across the ledge and wherein the pair of shoulders are positioned on opposing ends of the ledge.

9. The mounting system of claim 8, the claw further comprising a panel being positioned between the pair of shoulders.

10. A mounting system comprising:
a rail having a top wall, a bottom wall, and a pair of opposing lateral walls extending between the top wall and the bottom wall, the pair of opposing lateral walls being parallel to each other, the rail having a width being measured between the pair of opposing lateral walls, the rail having a height being measured between the top wall and the bottom wall, the rail being configured to extend between a plurality of balusters to define a railing;
a string decoration being removably positionable along the rail, the string decoration including a plurality of ornaments and a wire being coupled to and extending between the plurality of ornaments; and
a plurality of clips being removably couplable to the rail, the plurality of clips being couplable to the string decoration wherein the plurality of clips releasably secure a position of the string decoration along the rail, each clip of the plurality of clips including:
a rib being removably coupled to the rail, the rib having an upper surface, a lower surface, and a pair of opposing ends, the rib having a length being measured between the pair of opposing ends, the length of the rib being complementary to the width of the rail, the lower surface being concavely arcuate between the pair of opposing ends wherein the lower surface arches above the top wall of the rail to define a void being positioned between the top wall of the rail and the lower surface of the rib, the upper surface being convexly arcuate between the pair of opposing ends;
a pair of legs being coupled to the rib, each leg of the pair of legs having a length being complementary to the height of the rail wherein the pair of legs are positionable to extend between the rib and the bottom wall of the rail while the rib is positioned on top of the top wall of the rail, each leg of the pair of legs extending from a respective opposing end of the pair of opposing ends of the rib, the pair of legs being angled to extend downwardly from the rib and inwardly toward each other;
a pair of projections being coupled to the pair of legs wherein each projection of the pair of projections is positioned on a respective leg of the pair of legs, each projection of the pair of projections extending inwardly from the respective leg of the pair of legs wherein the pair of projections extend toward each other, each projection of the pair of projections being positioned distally on the respective leg of the pair of legs relative to the rib wherein the pair of projections are positionable against the bottom wall of the rail to removably couple the rib to the rail, the pair of projections being coplanar with each other; and
a claw being coupled to an associated leg of the pair of legs, the claw including:
a ledge extending outwardly from the associated leg of the pair of legs wherein the ledge extends outwardly relative to a respective opposing lateral wall of the pair of opposing lateral walls of the rail; and
a shoulder being coupled to the ledge, the shoulder being angled to extend upwardly from the ledge and inwardly toward the associated leg of the pair of legs wherein the shoulder releasably secures the string decoration to each clip of the plurality of clips and wherein the string decoration is positioned proximate to the respective opposing lateral wall of the pair of opposing lateral walls of the rail when the clip is coupled to the rail.

11. The mounting system of claim 10, wherein the ledge is horizontally coplanar with a respective projection of the pair of projections.

12. The mounting system of claim 11, wherein the shoulder has a width being equal to a width of the ledge.

13. The mounting system of claim 12, wherein the claw is one of a pair of claws wherein each claw of the pair of claws is coupled to an associated leg of the pair of legs and wherein each claw of the pair of claws releasably secures an associated string decoration of a pair of string decorations to the rail.

14. The mounting system of claim 11, wherein the shoulder is one of a pair of shoulders being spaced from each other across the ledge and wherein the pair of shoulders are positioned on opposing ends of the ledge.

15. The mounting system of claim 10, wherein the ledge is horizontally offset from a respective projection of the pair of projections and wherein the ledge is positioned between the rib and the respective projection of the pair of projections.

16. The mounting system of claim 15, wherein the shoulder is one of a pair of shoulders being spaced from each other across the ledge and wherein the pair of shoulders are positioned on opposing ends of the ledge, the claw further comprising a panel being positioned between the pair of shoulders, the panel having a width exceeding a width of each shoulder of the pair of shoulders wherein the panel extends a full distance between the pair of shoulders, the panel being perpendicular to the ledge.

17. The mounting system of claim 15, wherein the shoulder has a width being less than a width of the ledge, the claw further comprising a panel being coupled to and extending upwardly from the ledge, the panel being positioned adjacent to the shoulder wherein the ledge has a length being equal to a combined length of the shoulder and the panel, the panel being perpendicular to the ledge.

18. The mounting system of claim 15, wherein the shoulder has a width being less than a width of the ledge, the shoulder being centered on the ledge, the claw further comprising a fin being coupled to the shoulder, the fin extending outwardly from the shoulder and away from the associated leg of the pair of legs, the fin including:
a primary end;
a secondary end being spaced from the primary end to define a channel extending between the primary end and the secondary end, the channel being configured to receive the string decoration; and
an inner surface being concavely arcuate between the primary end and the secondary end wherein the fin defines a C-shape.

19. The mounting system of claim 18, wherein the primary end of the fin is positioned proximate to the associated leg of the pair of legs wherein the channel is perpendicular to an exterior surface of the associated leg of the pair of legs.

20. The mounting system of claim 18, wherein each of the primary end and the secondary end of the fin is spaced from the associated leg of the pair of legs, the primary end and the secondary end being aligned with each other wherein the channel extends toward an exterior surface of the associated leg of the pair of legs.
